(19) United States
(12) Patent Application Publication
(10) Pub. No.: US 2008/0098032 A1
(43) Pub. Date: Apr. 24, 2008

(54) MEDIA INSTANCE CONTENT OBJECTS

(75) Inventor: Vanessa Tieh-Su Wu, Vaxjo City SE (SE)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/552,014

(22) Filed: Oct. 23, 2006

(51) Int. Cl. G06F 17/00

(52) U.S. Cl. 707/104.1

(57) ABSTRACT

An editing process associates a content object with a media instance. In response to a command to serve the edited media instance, one or more content items, such as advertisements, are selected based on the associated content object and served with the edited media instance.

### BACKGROUND

Media instance, such as streamed audio and/or video files, can be presented on client devices, such as personal computers. Often the media instances can include advertisements, such as a commercial that precedes the subject content, or a logo overlay that is presented with the subject content. For example, presenting a video clip of a popular television program on a broadcast network may be preceded by a commercial for other programs on the network, and the video clip can include a network logo overlay during the presentation. Such advertisements, however, are usually inserted into the media instance during an editing process, or are based on metadata that are not content specific to the subject content of the media instance.

Additionally, such medial instances are usually produced by a first party or an entity acting under the authority of the first party, e.g., video clips for a television program are usually produced by the television program produces or by an advertising agency under contract to the television program producer. Third parties, such as users of a product or fans of an entertainment franchise, do not have a media editing environment to produce and distribute media instances that include associated data to facilitate the serving of content relevant advertisements.

### SUMMARY

Disclosed herein are systems and methods directed to media instances related to content and the selecting and serving of content relevant data (e.g., advertisements) for the media instances. In one implementation, a system includes a data store and a media editor subsystem. The data store stores content objects that include data to facilitate the selection of one or more content items (e.g., advertisements) related to the content objects from a content item source (e.g., an advertisement server). The media editor subsystem can be configured to receive a media instance and editing commands and perform editing operations on the media instance in response to the editing commands. The editing operations can include receiving a selection for one or more of the content objects and associating the selected content objects with the media instance.

In another implementation, a system includes a client device comprising a processing subsystem, an input/output subsystem, a data store and a communication subsystem. The processing device is in communication with the communication subsystem, the input/output subsystem, and the data store. The data store stores instructions that upon execution by the processing subsystem cause the client device to generate a media editor user interface and generate media editor commands. One media editor command can cause the selection of a media instance for editing by a media editor. Another media editor command can cause a selection of a content object for association with the media instance. The content object includes content metadata to facilitate selection of one or more content items (e.g., advertisement) based on the content metadata. Another media editor command can cause the storing of the edited media instance in a data store.

In another implementation, a video instance related to content is stored. The video instance includes an associated content object related to the content, and the content object includes data to facilitate the selection of one or more other content items (e.g., advertisements) related to the content object from a content item source (e.g., an advertisement server). The video instance can be served in response to a request.

In another implementation, a system includes a data store and an advertisement subsystem. The data store can store a video instance related to content. The video instance includes an associated content object related to the content that facilitates the selection of one or more advertisements related to the content. The advertisement subsystem is configured to select and serve one or more advertisements related to the associated content object.

In another implementation, software includes instructions that upon execution cause a processing device to receive an advertisement request related to a content object of a video instance related to content. The content object is related to the content. The instructions also cause the processing device to select one or more advertisements related to the content object and serve the selected one or more advertisements in response to the advertisement request.

Other example implementations can include one or more of the following features or advantages. The content objects can comprise static objects or dynamic objects that are presented with the media instance. The media instance and the advertisements can be combined into a single media stream. A content object manager can provide a user interface to upload and manage content objects. Accordingly, the content objects can facilitate the selection of content relevant advertisements during presentation of the media instance.

### BRIEF DESCRIPTION OF THE DRAWINGS

FIG. 1 is a block diagram of an example media instance processing system.

FIG. 2 is a block diagram of another example media instance processing system.

FIG. 3 is a block diagram of an example content object.

FIG. 4 is a block diagram of an example edited media instance data structure.

FIG. 5 is a block diagram of an example presentation of an edited media instance.

FIG. 6 is a screen shot of an example media editor user interface.

FIG. 7 is a screen shot of another example media editor user interface.

FIG. 8 is a flow diagram of an example process for editing a media instance.

FIG. 9 is a flow diagram of another example process for editing a media instance.

FIG. 10 is a flow diagram of an example process for serving the media instance and related content items.

FIG. 11 is a flow diagram of an example process for combining the media instance and related content items.

FIG. 12 is a flow diagram of an example process for transcoding an edited media instance.

FIG. 13 is a flow diagram of an example process for presenting a media instance and related content items.

FIG. 14 is a flow diagram of an example process for selecting and serving content items related to a video instance.

FIG. 15 is a flow diagram of an example process for managing content objects.

FIG. 16 is a flow diagram of an example process for generating a content object.

FIG. 17 is a flow diagram of an example process for defining an advertising campaign associated with content objects.

### DETAILED DESCRIPTION

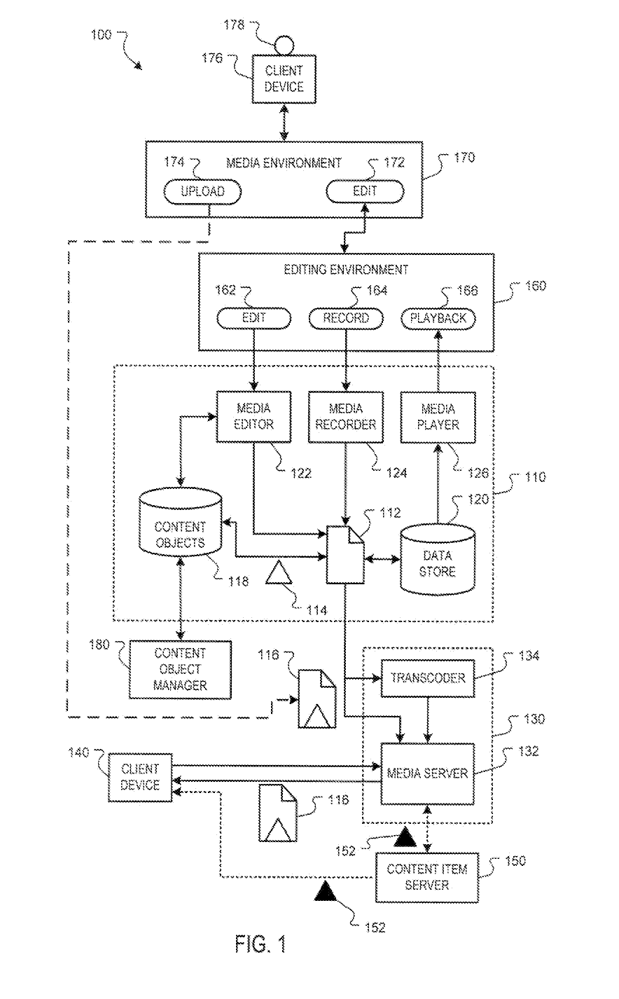

FIG. 1 is a block diagram of an example media instance processing system 100. In an implementation, the media instance processing system 100 includes an editor subsystem 110 that is configured to edit a media instance 112, such as a video file or an audio file. The editing process can include selecting a content object 114 and associating the content object 114 with the media instance 112 to produce an edited media instance 116. The media instance 112 and the edited media instance 116 can include, for example, audio files or audio streams, and video files, including still images and video, or video streams. In one implementation, the edited media instance 116 includes the media instance 112 and one or more content objects 114. The content objects 114 can be stored in a content object data store 118, such as a database. Another data store 120 can be used to store the media instance 112 during an editing process, and to store media instances 112 that may be selected or editing.

The edited media instance 116 can be provided to a publisher subsystem 130. In an implementation, the publisher subsystem 130 includes a media server 132 that is configured to store the edited media instance 116 and provide the edited media instance 116 to a requesting device in response to a media request, and/or push the edited media instance 116 or a link to the edited media instance 116 to a device in response to a push command. For example, a client device 140 may request the edited media instance 116 or may be configured to receive the edited media instance 116 automatically or based on a predefined event. The publisher subsystem 130 and the editing subsystem 110 can be implemented on a single computing device, or, alternatively, can be implemented as separate subsystems and communicate over a network, such a local area network (LAN), or a wide area network (WAN) e.g., one or more combinations of wired and wireless networks, the Internet, etc.

The content objects 114 can comprise data to facilitate the selection of one or more content items 152 related to the content objects 114 from a content item server 150. In one implementation, the content items 152 comprise advertisements and the content item server 150 comprises an advertisement server. Other types of content items 152 and content item servers 150 can also be used. For example, the content items 152 can comprise links to news articles and the content item server 150 can comprises a news server; or the content items 152 can comprise links to personal web pages and the content item server 150 can comprise a social networking server; or the content items 152 can comprise brief factual summaries and the content item server 150 can comprise a historical database; etc.

In an implementation, when provisioning the edited media instance 116 in response to a media request, the media server 132 can request content items, e.g., advertisements, from an content item server 150 based on the content object 114. The content item server 150 can select and serve one or more content items 152, e.g., advertisements to the media server 132 based on the content object 114 in response to the request from the media server 132. In one implementation, the media server 132 can provide the edited media instance 116 and the content items 152 as a single media instance, e.g., a single video stream, to a client device, such as the client device 140. The publisher subsystem 130, client device 140, and the content item server 150 can communicate over a network, such a LAN or a WAN, e.g., one or more combinations of wired and wireless networks, the Internet, etc.

In another implementation, the client device 140, upon receiving the edited media instance 116, can request content items, e.g., advertisements, from the content item server 150 based on the content object 114. In response, the content item server 150 can select and serve one or more content items 152 to the client device 140 based on the content object 114 and related to the content object 114 in response to the request.

In one implementation, the content object 114 data that facilitates the selection of one or more content items 152 can comprise metadata related to the media content. In another implementation, the content object 114 data that facilitates the selection of one or more content items 152 can comprise a code snippet, such as a JavaScript that causes the media server 132 or the client device 140 to issue a content item request to the content item server 150. Other data can also be used to facilitate the selection of content items 152 from the content item server 150.

In an implementation, the publisher subsystem 130 can include a transcoder 134 that is configured to transcode the edited media instance 116 into one or more media formats compatible with the one or more applications. For example, the edited media instance 116 can be a video file stored in a proprietary format; accordingly, the transcoder 134 can transcode the edited media instance 116 into another format that is more widely utilized in multiple devices, e.g., a Moving Pictures Expert Group (MPEG) format or a Windows Media Viewer (WMV) format. The transcoder 134 can be configured to preserve the content object 114 data that facilitates the selection of one or more content items 152 so that the presentation of each transcoded version of the edited media instance 116 can result in one or more content items 152 being presented during the presentation of the transcoded version of the edited media instance 116.

In an implementation, the content objects 114 can comprise an object that is presented with a media instance. For example, a content object 114 can comprise a static object, such as an image file or a sound file, that is presented during the presentation of an edited video instance with which the content object 114 is associated. For example, a thumbnail image of a produce may be presented in the edited media instance, or a sound file may be presented as a background sound environment during the presentation of the edited media instance.

A content object 114 can also comprise a dynamic object that is configured to be presented with the edited media instance 116 and change state during a presentation of the edited media instance 116. In an implementation, the dynamic object is selectable and includes a resource located associated with a landing page. Selection of a dynamic object at a client device, such as the client device 140, causes the client device to generate a browsing instance resolved to the landing page.

A content object 114 can also comprise an effects object that is configured to generate a media effect in the edited media instance 116. For example, a content object 114 can include a sepia visual effect to change a video instance from a full color video to a sepia tone video; or, a content object 114 can include an echo effect to introduce an echo in an audio stream.

Other types of content objects 114 can also be used. For example, a content object 114 can include metadata related to a category identifier that is relevant to a media instance, such as a “Birthday Greeting” and the like; a content object 114 can include an audio object to be presented with the media instance, such as a song in a karaoke video.

In an implementation, the media instance processing system 100 includes a media editor 122, a media recorder 124, and a media player 126. The media editor 122, the media recorder 124 and the media player 126 can be components of the editor subsystem 110. The media editor 122 can access a media instance 112 and perform editing operations on the media instance 112. The editing operations can include selecting and associating a content object 114 with the media instance 112. The media recorder 124 can receive media instance data, such as an audio or video input stream, and store the received media instance data as a media instance 112. The media player 126 can access the stored media instance 112 or the edited media instance 116 and present the stored media instance 112 or the edited media instance 116 to a user that is recording and/or editing the media instance 112 or editing the edited media instance 116.

In an implementation, the media editor 122, the media recorder 124 and the media player 126 can be accessed through an editing environment 160 to record, edit and review media instances. The editing environment 160 can, for example, be generated by invoking an edit function 172 in a media environment 170 at a processing device, such as a client device 176. The invocation of the edit function 172 generates the editing environment 160, which, in turn, includes an edit function 162, a record function 164, and a playback function 166. The client device 176 can communicate with the editor subsystem over a network, such as a LAN or a WAN, e.g., one or more combinations of wired and wireless networks, the Internet, etc.

Selecting an edit function 162 in the editing environment 160 enables a user of the client device 176 to generate editing commands for editing a media instance 112 or edit an edited media instance 116. The editing commands are, in turn, transmitted to the media editor 122 to edit a selected media instance. The media editor 122 can edit a selected media instance by adding or deleting media data. e.g., adding or deleting a scene, or adding audio commentary to a video stream; by applying one or more media effects, such as a video or audio effect; or by performing other editing operations.

Additionally, the media editor 122 can associate one or more content objects 114 with the selected media instance. In an implementation, the editing operations described above can be facilitated in part by content objects 114. For example, a content object 114 can include video clips from a movie scheduled for an upcoming release, e.g., a series of dialog scenes of an actor in the movie. The movie producer may sponsor a contest in which fans of the movie submit a personal video spliced with the dialog scenes of the actor. The personal video can initially be stored as a media instance 112, and the content object 114 that includes the cut scenes can be spliced into the personal video. The final videos can be stored as edited media instances 116 at the media server 132, and each time one of the edited media instances 116 are provided for presentation, one or more content items 152 relevant to the content object 114 can be presented with the edited media instance 116.

The content items 152 can vary depending on the context in which the edited media instance is presented; for example, during the theatrical run of the movie, the content items 152 may relate to merchandise related to the movie, or may relate to theaters in nearby locations that are showing the movie. After the theatrical release, the content items 152 may relate to a DVD release of the movie, or may relate to a sequel of the movie. After the DVD release, the content items 152 may relate to other movies that are being produced by the movie producer, or may relate to other movies in which the actor is starring.

By way of another example, a content object 114 may be an audio file, such as a musical composition for karaoke. A user may select the content object 114 and create a media instance 112 as a video karaoke. The final video karaoke can be stored as an edited media instance 116 at the media server 132, and each time the edited media instance 116 is provided for presentation, one or more content items 152 relevant to the content object 114 can be presented with the edited media instance 116. For example, content items for on-line sales of recordings of the original recording artist of the musical composition can be presented with the edited media instance 116. Likewise, a logo overlay of the record label that owns the rights to the song can be presented during the presentation of the edited media instance, e.g., a trademark or symbol associated with the record label. Other overlay information can also be included, e.g., text that reads “This video karaoke is brought to you by ABC Records.” If the rights are later sold to another record label, then the overlay can likewise be updated, e.g. “This video karaoke is brought to you by XYZ Records.”

Selecting the record function 164 in the editing environment 160 enables a user of the client device 176 to generate and record a media instance 112. In one implementation, media data for the media instance 112 can be generated by an input device 178 at the client device 176. Example input devices 178 include video cameras and audio input devices. The media data can, for example, be collected by a media recorder 124 and stored as a media instance 112.

Selecting the playback function 166 in the editing environment 160 enables a user of the client device 176 to play back a media instance 112 or playback an edited media instance 116 on a media player 126. The playback function 166 can, for example, be invoked to review a selected media instance before editing, or to review a media instance during an editing process.

Once a user decides that no further edits are required for an edited media instance 116, the edited media instance 116 can be provided to the publisher subsystem 130 by invoking, for example, an upload function 174 in the media environment 170. The upload function 174 causes the edited media instance 116 to be provided to the publisher subsystem 130. In one implementation, the publisher subsystem 130 can comprise computer devices hosting a personal account associated with the user, e.g., a user's website in a social networking web hosting service. In another implementation, the publisher subsystem 130 can comprise computer devices associated with a third party, e.g., a web hosting service that is hosting licensed content for a movie production studio or a record label.

The media instance processing system 100 can also include a content object manager 180. The content object manager 180 can be configured to store and delete content objects 114 in the content objects data store 118. In an implementation, the content object manager 180 can also be configured to manage one or more customer accounts and associate content objects 114 with corresponding customer accounts. For example, a record label may periodically upload content objects 114, such as karaoke sound files, e.g., WAV or MP3 files, and artist image files, e.g., jpeg or gif files, with associated data to facilitate content item selections from the content item server 150, to the content object data store 118. Additionally, the content object manager 180 can edit and/or delete content objects 114 stored in the content objects data store 118.

In an implementation, the media processing system 100 facilitates the recording and/or editing of media instances, such as video streams, in an on-line environment. The edited media instances 116 can be pushed to recipients and content relevant content items 152 based one or more content objects 114 can be selected and served upon the presentation of the edited media instance 116.

The content objects 114 can include media data, such as video and/or audio data, and data to facilitate the selection of content relevant content items, such as metadata or code snippets. The content objects 114 can be created by and managed by third parties, e.g., an owner of a copyright to the content or a manufacturer of a product depicted as an image in a content object 114.

In another implementation, a content object 114 can be automatically associated with a media instance 112, and the content object 114 need not be visually or aurally discernable. For example, content objects can comprise data identifying a category, e.g., a brand of motorcycle. Thus, a motorcycle enthusiast may record a video blog about a motorcycle ride and post the video blog to a video blog site sponsored by the brand owner for motorcycle enthusiasts. Each time the video is served, a motorcycle related content items, e.g., advertisements, related to the motorcycle brand can be generated based on the content object 114.

The media instance processing system 100 can, for example, be implemented in multiple computer devices in data communication over one or more computer networks. For example, the editing subsystem 110 can be implemented by a computer device, such as a server, executing software configured to perform the editing, recording, and playback operations described above. Likewise, the publishing subsystem 130 and the content item server 150 can be implemented by computer devices, such as servers, executing software configured to perform the operations and functions described above. The content object manager 180 can also be implemented in one or more computer devices executing appropriately designed software. For example, the content object manager 180 can include a server portion to store and manage the content objects in the data store 118, and a client portion located on a customer (e.g., an advertiser) computer to access the server portion.

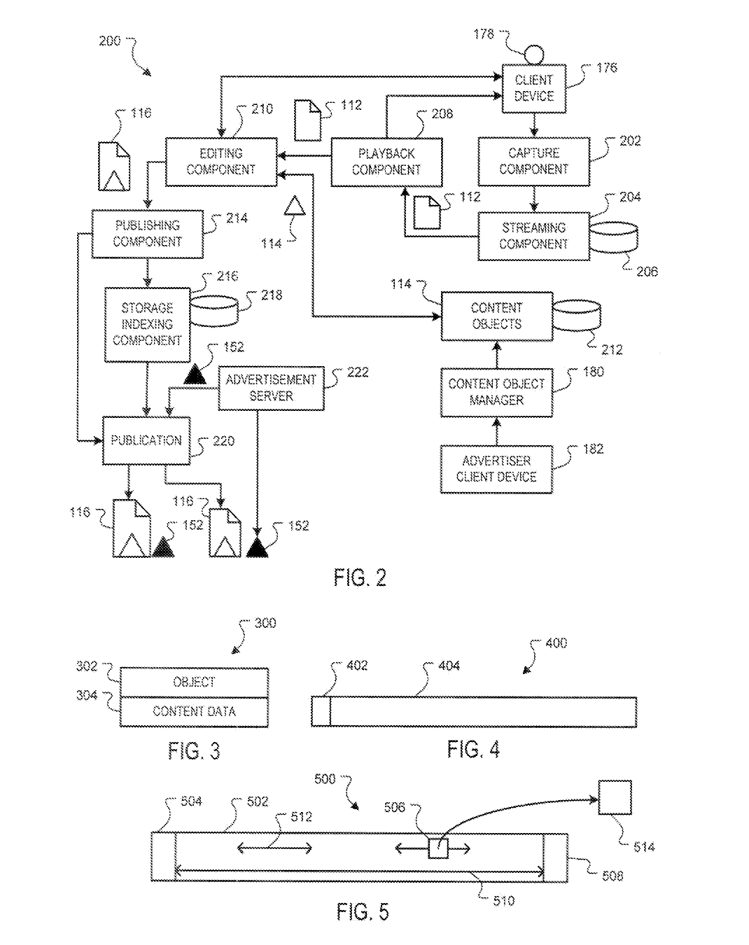

FIG. 2 is a block diagram of another example media instance processing system 200. The system 200 can, for example, be used to implement the system 100 of FIG. 1 to select and serve advertisement content items. The example media instance processing system 200 can be implemented in a plurality of computer devices in data communication over a network, such as a LAN or a WAN, e.g., one or more combinations of wired and wireless networks, the Internet, etc. Example computer devices that can be used include personal computers, servers, mobile devices, such as mobile computers and mobile communication devices, and the like.

In the example media instance processing system 200, a client device 176, such as a personal computer, can include a data input device 178, such as a web camera connect to a personal computer, or a web camera in a mobile communication device, to capture media data. A capture component 202, such as a flash plug-in or an applet, can be used to provide the media data from the data input device 178 to a streaming component 204. In one implementation, the streaming component 204 is implemented on a server in data communication with the client device 176 over a network, such as the Internet. The streaming component 204 can create the media instance 112 and store the media instance 112 in a data store 206, such as the data store 120 of FIG. 1, for example.

A playback component 208, such as a flash plug-in or an applet, can be used to retrieve a media instance 112 and stream the media instance back to the client device 176 for review. The playback component can also provide the media instance 112 to an editing component 210. The editing component 210 can include a media editor that is configured to edit the media data of the media instance 112. An editing process can include the selection of one or more content objects 114 from a data store 212, such as the content object data store 118 of FIG. 1. The selected content object 114 can be associated with the media instance 112 to create an edited media instance 116.

The edited media instance 116 can be provided to a publishing component 214 for serving and/or pushing to one or more computing devices. For example, the publishing component 214 can provide the edited media instance 116 to a storage indexing component 216 that indexes the edited media instance 116 and stores the index in a data store 218, such as a database. The index of the edited media instance 116 can be utilized by a search engine for relevance determinations relating to a search. If the edited media instance 116 is determined to be relevant to the search, the edited media instance 116 can be provided as a search result by a publication 220. In an implementation, the publication 220 can be implemented by a search engine that publishes a link to the edited media instance 116.

In another implementation, a publication 220 can include the publishing component 214 providing the edited media instance 116 or a link to the edited media instance 116 to one or more computing devices. In this implementation, the indexing of the edited media instance 116 need not be implemented. For example, a user of the client device 176 may create a karaoke song video and send a link to several acquaintances in a social network.

In another implementation, a publication 220 can include a subscription prerequisite to view the edited media instance 116. For example, a user may be required to subscribe to a service to view one or more edited media instance 116. The subscription can, for example, be a free subscription or can be a fee-based subscription. In anther implementation, a user may specify other users that may view the edited media instance 116, e.g., the edited media instance 116 may be categorized as “private” and the user may specific a list of approved users that may receive and/or view the edited media instance, or the edited media instance 116 may be categorized as “public” so that any user may receive and/or view the edited media instance 116.

In one implementation, the publishing component 214 can transcode the edited media instance 116 into one or more media formats compatible with the one or more applications. For example, publishing component 214 can transcode the edited media instance 116 from a proprietary format to one or more other formats, such as MPEG or WMV formats.

In one implementation, publication of the edited media instance 116 can include selecting and serving advertisements 152 by an advertisement server 222, and combining the advertisements 152 and the edited media instance 116 into a single stream that is provided to a client device upon requesting the edited media instance. In another implementation, upon receiving the edited media instance 116, a client device issues an advertisement request to the advertisement server 222 and presents the advertisements 152 that are received. The advertisements can be presented in the same media environment, e.g., in a same viewing frame for a video instance, such as a log overlay; or in a separate media frame, e.g., textual advertisements that are presented adjacent the media frame.

The media instance processing system 200 can also include a content object manager 180. The content object manager 180 can be configured to store, modify and/or delete content objects 114 in the content objects data store 212. In am implementation, the content object manager 180 can also be configured to manage one or more advertiser accounts and associate content objects 114 with corresponding advertiser accounts. The content object manage 180 can, for example, be accessed by a client device, such as an advertiser client device 182.

The streaming component 204, playback component 208, the editing component 210, the publishing component 214, the storage indexing component 216 and the content object manager 180 can be implemented in one or more computer devices in data communication over a network and executing software to perform the operations and functions described above. For example, the streaming component 204, the playback component 208 and the editing component 210 can be implemented in a server computer executing a corresponding capture, streaming, playback and editing software; the publishing component 214, the storage indexing component 216 and the advertisement server 222 can be implemented in a server farm or servers in data communication over a network and executing corresponding publishing, indexing and advertisement serving software; and the content object manager 180 can be implemented in a server in data communication with the content object data store 212 and executing corresponding content object managing software.

FIG. 3 is a block diagram of an example content object 300. The example content object 300 includes an object 302 and content data 304. The object 302 can comprise an object that is presented during a presentation of the edited media instance 116, such as a static object, a dynamic object, or an effects object. The object can be a discernable object, e.g., a video object that is viewed during a video presentation or an audio object that is heard during an audio presentation.

The content data 304 includes data related to the content of the object 302. In one implementation, the content data 304 can be configured to facilitate the searching and selecting of relevant advertisements from an advertisement server. For example, the content data 304 can comprise content metadata describing the object and interests related to the object, e.g., if the object 302 is a flash animation of a motorcycle, the metadata can include the motorcycle model, the name of the manufacturer, and a query for a nearest dealer that gathers geographic data upon execution during a presentation of an edited media instance 116. The content data 304 can, for example, also comprise a code snippet, such as a JavaScript compatible code that is executed by a client device upon receiving or presenting the edited media instance. The code snippet can, for example, cause the client device to issue one or more advertisement requests, or requests for other content item types, to a content item server.

FIG. 4 is a block diagram of an example edited media instance data structure 400. The data structure 400 can include a header section 402 and a payload section 404. The header section 402 can include corresponding content data 304, and the payload section 404 can include the media data of the edited media instance 116.

The example edited media instance data structure 400 includes both media data and corresponding content data 304. In another implementation, however, the content data 304 and the media data can be transmitted as separate data entities.

FIG. 5 is a block diagram of an example presentation 500 of an edited media instance 116. The presentation 500 can include a media content presentation 502, e.g., a playback of a karaoke video clip. The media content presentation 502 can, for example, be preceded by one or more content items 504, e.g., advertisements, that are selected based on a content object, such as the content object 506. Likewise, the media content presentation 502 can, for example, be followed by one or more content items 508, e.g., advertisements that are selected based on a content object, such as the content object 506.

The media content presentation 502 can, for example, also include a content item inserted into the media content presentation 502, such as an overlay advertisement 510 that is present for the duration of the media content presentation 502, e.g., an overlay that reads “This karaoke is brought to you by ABC Records” or a logo overlay. Likewise, the media presentation 502 can also include a content item 512 inserted into the media content presentation 502 that is present only for a portion of the media content presentation 502, such as a selectable overlay that reads “If you would like to buy this song or other songs that may interest you, click here now,” the selection of which can open a browsing instance for an on-line music store.

The media content presentation 502 can also include a content object, such as the content object 506. The content object 506 can, for example, be a dynamic object that includes a link, such as a resource locator. The selection of the dynamic object 506 can, for example, generate a browsing instance that is resolved to a landing page associated with the selectable link. For example, the content object 506 can be an image of an automobile that appears during the media content presentation 502, and clicking on the content object can open a browsing instance resolved to a landing page associated with the manufacturer of the automobile depicted in the image.

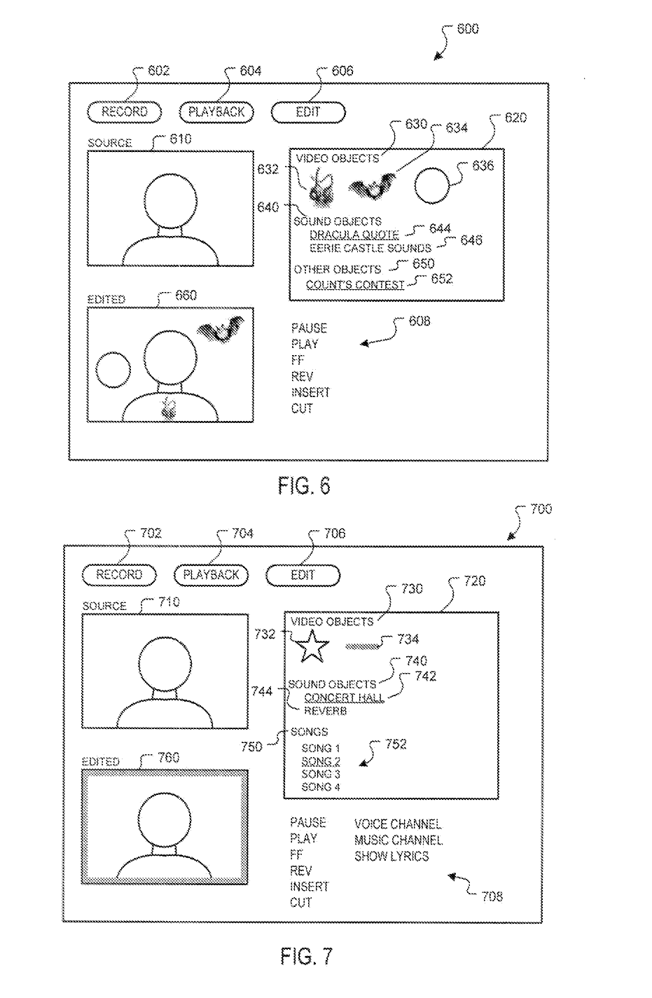

FIG. 6 is a screen shot of an example media editor user interface 600. The user interface 600 can be generated, for example, at a client device, such as the client device 176 of FIGS. 1 and 2. The user interface 600 includes a record menu 602, a playback menu 604, and an edit menu 606. In one implementation, the selection of a menu item 602, 604 or 606 can generate corresponding menu commands 608. For example, the menu commands 608 are editing commands in response to the edit menu 606 being selected.

The example user interface 600 is an interface for editing video instances. Accordingly, a source environment 610 displays source video data, e.g., a video file that a user has selected for editing. In one implementation, the video file can be provided by a third party. In another implementation, the video file can be a video stream that is or has been generated from a camera on a client device, such as a user's personal computer.

A content object pane 620 displays content objects that a user may select for inclusion into the selected video instance during an editing process. The content objects can be provided by a third party, e.g., a production studio for a motion picture. The content objects can include video content objects 630 that are visually discernable during the presentation of the edited video instance. For example, the video content objects 630 can include an image of a garlic clove 632, a bat 634, and a headshot 636 of an actor starring in a movie related to the fictional character of Dracula.

The content objects can include audio content objects 640 that are aurally discernable during the presentation of the edited video instance. For example, the audio content objects 640 can include a “Dracula Quote” audio content object 642 that inserts a random quote from a Dracula character in the subject movie, and an “Eerie Castle Sounds” audio content object 644 that generates castle sounds at random intervals.

The content objects can also include other content objects 650, such as a contest object 652 that can provide a random gift, e.g., free tickets to a movie or a free copy of a DVD of the movie, when the edited video instance is presented.

As described above, the content objects can be static objects, dynamic objects, or other types of objects. For example, the video content object 634 can be a dynamic object that, upon selection, generates a list of nearby theaters with show times for the subject movie. Likewise, the video content object 636 can be a dynamic object that, upon selection, generates biographical information related to the actor depicted in video content object 636.

An edited environment 660 displays an edited version of the video instance displayed in the source environment 610. For example, the edited version of the video instance displayed in the source environment 610 includes the video content objects 632, 634 and 636, the audio content object 642 and the contest object 652.

In one implementation, the media editor user interface 600 can be managed by a party affiliated with the subject content, e.g., a production studio, and can be used by third parties to generated edited video instances of the subject content, e.g., fans can access the media editor user interface 600 to generate fan videos related to the subject content.

Each of the content objects includes content data that can facilitate the selection and serving of content relevant content items, e.g., advertisements. The media editor user interface 600 can, for example, provide a virtual advertising agency in which the interested users may generate and distribute video instances that, upon presentation, generate content relevant advertisements. For example, during the theatrical run of the movie, the advertisements may relate to merchandise related to the movie, or may relate to theaters in nearby locations that are showing the movie. After the theatrical release, the advertisements may relate to a DVD release of the movie, or may relate to a sequel of the movie. After the DVD release, the advertisements may relate to other movies that are being produced by the movie producer, or may relate to other movies in which the actor is starring.

FIG. 7 is a screen shot of another example media editor user interface 700. The user interface 700 can be generated, for example, at a client device, such as the client device 176 of FIGS. 1 and 2. The user interface 700 includes a record menu 702, a playback menu 704, and an edit menu 706. In one implementation, the selection of a menu item 702, 704 or 706 can generate corresponding menu commands 708. For example, the menu commands 708 are editing commands in response to the edit menu being selected.

The example user interface 700 is an interface for editing video karaoke instances. Accordingly, a source environment 710 displays source video data, e.g., a video file that a user has selected for editing, such as a video stream that is or has been generated from a camera on a client device, such as the user's personal computer.

A content object pane 720 displays content objects that a user may select for inclusion into the selected video instance during an editing process. The content objects can be provided by a third party, e.g., a record label that owns rights in the songs that can be selected for karaoke singing. The content objects can include video content objects 730 that are visually discernable during the presentation of the edited video instance. For example, the video content objects 730 can include an image of a star 732 and a border design 734.

The content objects can include audio content objects 740 that are aurally discernable during the presentation of the edited video instance. For example, the audio content objects 740 can include a “Concert Hall” audio filter that modulates a user's voice by an absorption constant, and a “Reverb” audio object 644 that generates a reverberation effect in the user's voice.

The content objects can also include song content objects 750, such as a collection of songs 752 that may be selected for karaoke singing. The selected song content object 752, e.g., “Song 2” can include content data that can facilitate the selection and serving of the content relevant content items, e.g., advertisements, links to fan sites, etc. For example, advertisements for on-line sales of recordings of the original recording artist of “Song 2” can be presented with the video karaoke instance. Likewise, a logo overlay of the studio that publishes songs for the original recording artist can be present during the presentation of the video karaoke instance, or some other overlay, e.g., “This video karaoke is brought to you by ABC Records.” Alternatively, an overlay for a fan site for the recording artist can be presented during the presentation of the video karaoke instance, e.g., “Visit this artist's only official fan site by clicking here now.”

An edited environment 760 displays an edited version of the video instance displayed in the source environment 710. For example, the edited version of the video karaoke instance of the song “Song 2” displayed in the source environment 710 includes the video objects 734 and the sound object 742.

In one implementation, a user can listen to a karaoke song file by a personal output device, e.g., a headset or ear buds, to preclude feedback from a microphone that is used to record the user's voice. The voice recording can be stored as a separate file, edited, and mixed with the original karaoke song file and stored as a single sound file. Other recording environments and processes can also be used.

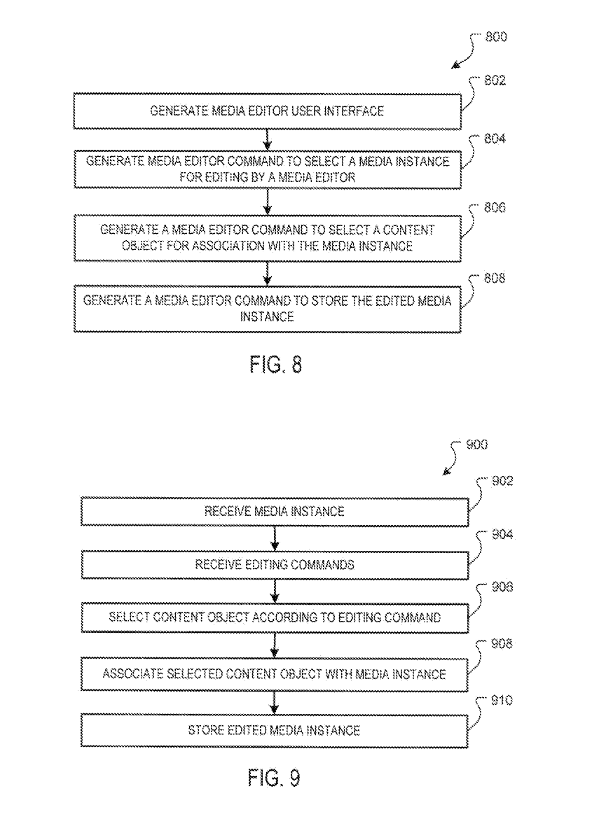

FIG. 8 is a flow diagram of an example process 800 for editing a media instance. The example process 800 can, for example, be implemented in the editor subsystem 110 and/or the client device 176 of FIG. 1, or can be implemented in the capture component 202, streaming component 204, playback component 208, editing component 210, and/or the client device 176 of FIG. 2. Other implementations can also be used.

Stage 802 generates a media editor user interface. For example, the client device 176, executing an applet or a browser plug in component, can generate a media editor user interface. The media editor user interface can, for example, be the user interface 600 of FIG. 6, or the user interface 700 of FIG. 7. Other media editor user interfaces can also be generated.

Stage 804 generates a media editor command to select a media instance for editing by a media editor. For example, the client device 176 of FIG. 1 or 2 can generate the media editor command to select a media instance for editing by a media editor, such as the media instance 112 for editing by the media editor 122 of FIG. 1 or the editing component 210 of FIG. 2.

Stage 806 generates a media editor command to select a content object for association with the media instance. For example, the client device 176 of FIG. 1 or 2 can generate the media editor command to select a content object for association with the media instance, such as the content object 114 and the media instance 112 of FIGS. 1 and 2.

Stage 808 generates a media editor command to store the edited media instance. For example, the client device 176 of FIG. 1 or 2 can generate the media editor command to store the edited media instance 116, such as in the data store 120 or in the media server 132 of FIG. 1, or a in the data store 206 or the publishing component 214 of FIG. 2.

FIG. 9 is a flow diagram of another example process 900 for editing a media instance. The example process 900 can, for example, be implemented in the editor subsystem 110 of FIG. 1, or can be implemented in the capture component 202, streaming component 204, playback component 208, editing component 210 and publishing component 214 of FIG. 2. Other implementations can also be used.

Stage 902 receives a media instance. For example, media recorder 124 and/or the media editor 122 of FIG. 1 can receive the media instance 112; or the streaming component 204 and the editing component 210 of FIG. 2 can receive the media instance 112.

Stage 904 receives editing commands. For example, the media editor 122 of FIG. 1 or the editing component 210 of FIG. 2 can receive commands from a client device to edit the media instance received in stage 902.

Stage 906 selects a content object according to the editing command. For example, the media editor 122 of FIG. 1 or the editing component 210 of FIG. 2 can select a content object, such as the content object 114, from a content object data store. The content object 114 can be a static object, a dynamic object, an effects object, or some other type of content object 114 that includes content data to facilitate selection of one or more content relevant content items, e.g., advertisements, links to other sites, quotes, etc.

Stage 908 associates a selected content object with the media instance. For example, the media editor 122 of FIG. 1 or the editing component 210 of FIG. 2 can associate the content object 114 with the media instance 112. In one implementation, the association results in the content object 114 being discernable in the edited media instance, e.g., a visual or audio effect is implemented, or an image is displayed in the media instance.

Stage 910 stores the edited media instance. For example, the media editor 122 of FIG. 1 can store the edited media instance in the data store 120 and/or the media server 132 of FIG. 1, or the editing component 210 can store the edited media instance the publishing component 214 of FIG. 2.

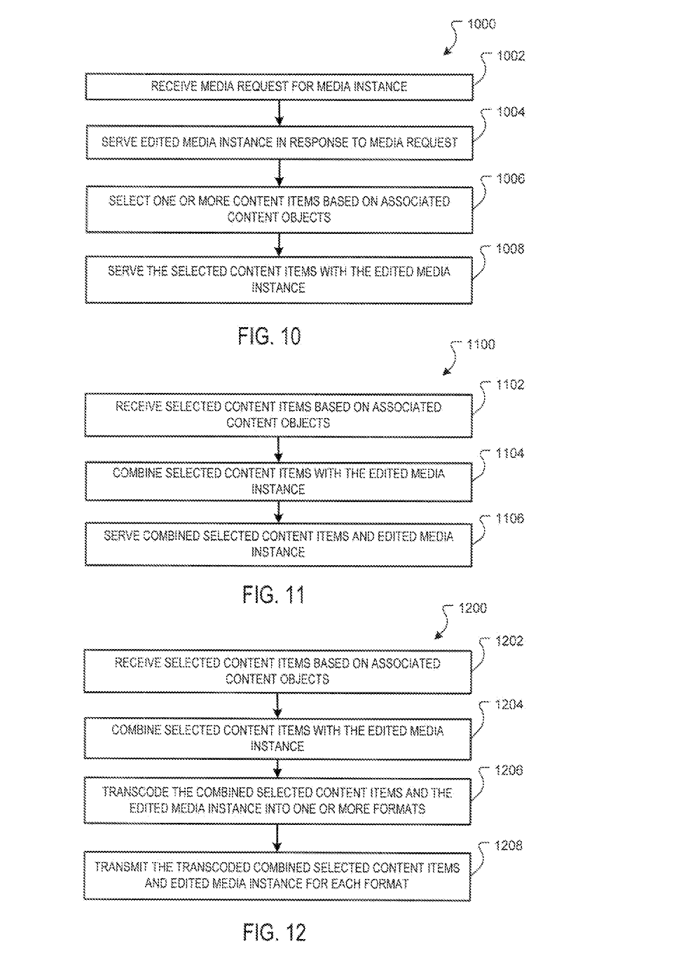

FIG. 10 is a flow diagram of an example process 1000 for serving the media instance and related content items. The example process 100 can, for example, be implemented in the publisher subsystem 130 and the content item server 150 of FIG. 1, or in the publishing component 214 and the advertisement server 222 of FIG. 2. Other implementations can also be used.

Stage 1002 receives a media request for a media instance. For example, the publisher subsystem 130 of FIG. 1 or the publishing component 214 of FIG. 2 can receive a request for a media instance. The request can, for example, be generated by a client device.

Stage 1004 serves an edited media instance in response to the media request. For example, the publisher subsystem 130 of FIG. 1 or the publishing component 214 of FIG. 2 transmits the edited media instance 116 to the client device as a media stream.

Stage 1006 selected one or more content items based on content objects associated with the edited media instance. For example, in one implementation, the requesting client device can generate content items requests, e.g., advertisement requests based on the content data of associated content objects and transmit the requests to the content item server 150 of FIG. 1, or the advertisement server 222 of FIG. 2. In another implementation, the publisher subsystem 130 of FIG. 1 or the publishing component 214 of FIG. 2 can generate the content item requests upon receiving a request for the edited media instance. The content item requests, in turn, are utilized by a content item server, such as the content item server 150 or the advertisement server 222, to select one or more content items based on the associated content objects.

Stage 1008 serves the selected content items with the edited media instance. For example, in the implementation in which the client device generates an advertisement request, the content item server 150 of FIG. 1 or the advertisement server 222 of FIG. 2 can select one or more advertisements based on content objects associated with the edited media instance and transmit the advertisements to the requesting client device. In the implementation in which the publisher subsystem 130 of FIG. 1 or the publishing component 214 of FIG. 2 generates an advertisement request, the content item server 150 of FIG. 1 or the advertisement server 222 of FIG. 2 can select one or more advertisements based on content objects associated with the edited media instance and transmit the advertisements to the publisher subsystem 130 of FIG. 1 or the publishing component 214 of FIG. 2, which, in turn, can then provide the selected advertisements with the edited media instance.

FIG. 11 is a flow diagram of an example process 1100 for combining the media instance and related content items, e.g., advertisements. The example process 1100 can, for example, be implemented by the publisher subsystem 130 of FIG. 1 or the publishing component 214 of FIG. 2. Other implementations can also be used.

Stage 1102 receives selected content items based on content objects associated with an edited media instance. For example, the publisher subsystem 130 of FIG. 1 or the publishing component 214 of FIG. 2 can receive selected advertisements from an advertisement server.

Stage 1104 combines the selected content items with the edited media instance. For example, the publisher subsystem 130 of FIG. 1 or the publishing component 214 of FIG. 2 can combine the selected advertisements with the edited media instance 116 into a single stream.

Stage 1106 serves the combined selected content items and the edited media instance. For example, the publisher subsystem 130 of FIG. 1 or the publishing component 214 of FIG. 2 can serve the combined selected advertisements and edited media instance to a requesting client device.

FIG. 12 is a flow diagram of an example process 1200 for transcoding an edited media instance. The example process 1200 can, for example, be implemented by the publisher subsystem 130 of FIG. 1 or the publishing component 214 of FIG. 2. Other implementations can also be used.

Stage 1202 receives selected content items based on content objects associated with an edited media instance. For example, the publisher subsystem 130 of FIG. 1 or the publishing component 214 of FIG. 2 can receive the selected advertisements for an advertisement server.

Stage 1204 combines the selected content items with the edited media instance. For example, the publisher subsystem 130 of FIG. 1 or the publishing component 214 of FIG. 2 can combine the selected advertisements with the edited media instance 116.

Stage 1206 transcodes the combined selected content items and the edited media instance into one or more formats. For example, the publisher subsystem 130 of GIG. 1 or the publishing component 214 of FIG. 2 can transcode the combined selected advertisements and the edited media instance 116 from a proprietary format into a widely accepted format, such as the MPEG or WMV formats.

Stage 1208 transmits the transcoded combined selected content items and the edited media instance for each format. For example, the publisher subsystem 130 of FIG. 1 or the publishing component 214 of FIG. 2 can transmit the transcoded advertisements and the media instance to client devices that are able to receive and process the media instance in the transcoded format.

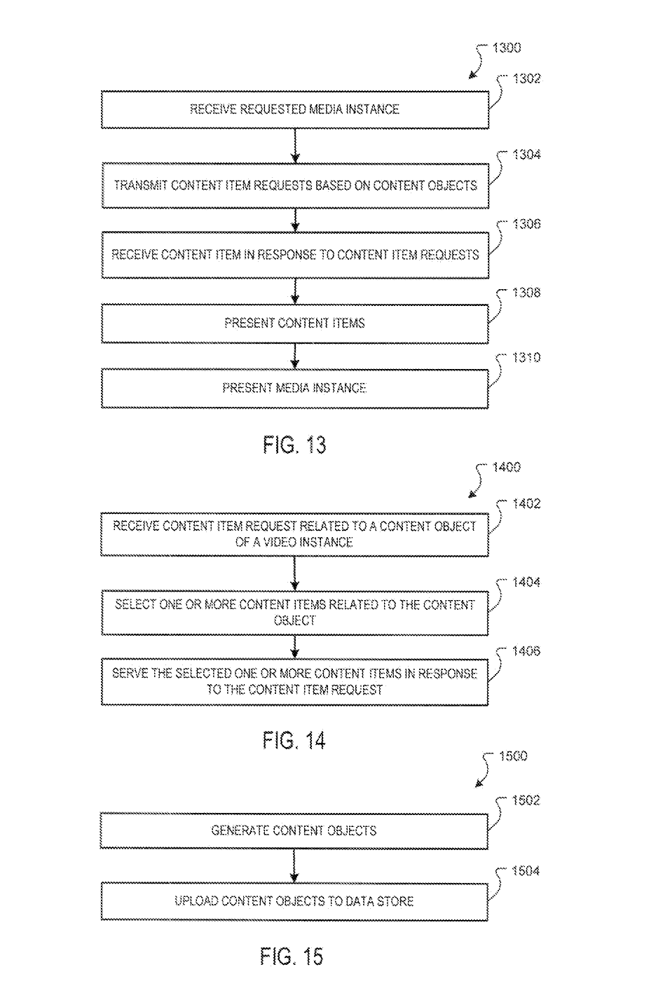

FIG. 13 is a flow diagram of an example process 1300 for presenting a media instance and related content items. The example process 1300 can, for example, be implemented in a client device, such as the client device 140 of FIG. 1. Other implementations can also be used.

Stage 1302 receives a requested media instance. For example, the client device 140 of FIG. 1 may receive an edited media instance in response to a request or in response to selecting a link to the edited media instance.

Stage 1304 transmits content item requests based on content objects associated with the edited media instance. For example, the client device 140 of FIG. 1 can transmit advertisement requests in response to the content data 304 of a content object 114, e.g., a JavaScript can be executed at the client device 140 that causes the client device to transmit an advertisement request to an advertisement server.

Stage 1306 receives content items in response to the content item requests. For example, the client device 140 of FIG. 1 can receive advertisements selected and served by the advertisement server.

Stage 1308 presents the content items, and stage 1310 presents the media instance. For example, the advertisements may be presented as described with respect to FIG. 5, e.g., either before, during or after the presentation of the media instance. Likewise, the content objects 114 associated with the media instance can also be presented with the media instance 114 if the content objects are visually or aurally discernable.

FIG. 14 is a flow diagram of an example process 1400 for selecting and serving content items related to a vide instance. The example process 1400 can, for example, be implemented in a content item server, such as the content items server 150 of FIG. 1 or the advertisement server 222 of FIG. 2. Other implementations can also be used.

Stage 1402 receives a content item request related to a content object of a video instance. For example, a content item server, such as the content items server 150 of FIG. 1 or the advertisement server 222 of FIG. 2, can receive an advertisement request related to a content object of a video instance. The advertisement request can, for example, be issued from a client device, such as client device 140, or by a publishing subsystem, such as the publisher subsystem 130 of FIG. 1 or the publishing component 214 of FIG. 2.

Stage 1404 selects one or more content items related to the content object. For example, the content item server 150 of FIG. 1 or the advertisement server 222 of FIG. 2 can select one or more advertisements related to the content object 114 in an edited media instance 116.

Stage 1406 serves the selected one or more content items in response to the content item request. For example, the content item server 150 of FIG. 1 or the advertisement server 222 of FIG. 2 can transmit the selected advertisements to a requesting device, such as a client device 140 or the publisher subsystem 130 of FIG. 1 or the publishing component 214 of FIG. 2, respectively.

FIG. 15 is a flow diagram of an example process 1500 for managing content objects. The example process 1500 can be implemented in the content object manager 180 of FIGS. 1 and 2, and/or in an associated client device, such as the client device 182 of FIG. 2. Other implementations can also be used.

Stage 1502 generates or otherwise identifies content objects. For example, a client device, such as the client device 182, may be used to generate content objects, such as static objects, dynamic objects, effects objects, etc.

Stage 1504 uploads the content objects to a data store. For example, the client device 182 and/or the content object manager 180 can upload the content objects generated in stage 1502 to a content object data store, such as the data store 118 of FIG. 1 or the data store 212 of FIG. 2.

FIG. 16 is a flow diagram of an example process 1600 for generating a content object. The example process 1600 can be implemented in the content object manager 180 of FIGS. 1 and 2, and/or in an associated client device, such as the client device 182 of FIG. 2. Other implementations can also be used.

Stage 1602 generates otherwise identifies an object. For example, the client device 182 and/or the content object manager 180 can be used to generate a video object, such as a still image or an animation; or an audio object, such as an effects filter or a song file; or other objects for use in a content object, such as static objects, dynamic objects, effects objects, and the like.

Stage 1604 generates or otherwise identifies content data. For example, the client device 182 and/or the content object manager 180 can be used to generate metadata and other data related to the object generated in stage 1602. Thus, if the object is a motorcycle image, the metadata can specify the model of the motorcycle, the manufacture of the motorcycle, and/or a code snippet to cause another client device that present the content object to provide geographic data and a query for nearby motorcycle dealers.

Stage 1606 associates the content data and the object as an entity, e.g., as a content object. For example, the client device 182 and/or the content object manager 180 can associate the object and content data to define a content object.

Stage 1608 stores the associated content data and object as a content object. For example, the client device 182 and/or the content object manager 180 can store the associated content data and object in a data file to create a content object.

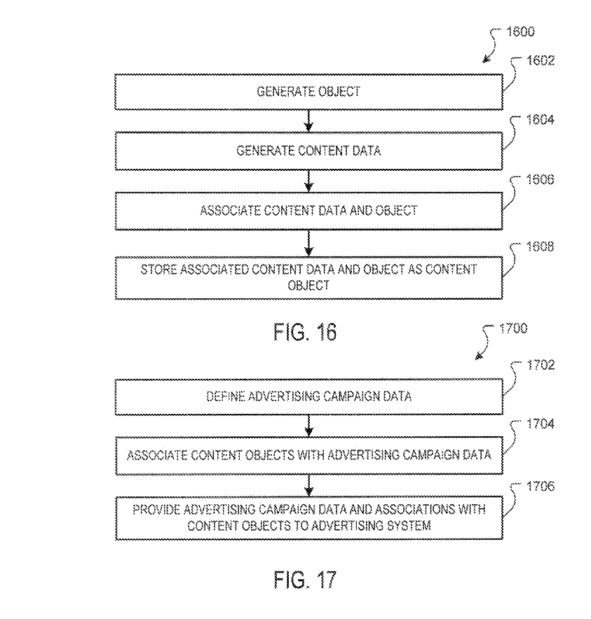

FIG. 17 is a flow diagram of an example process 1700 for defining an advertising campaign associated with content objects. The example process 1700 can be implemented in the content object manager 180 of FIGS. 1 and 2, and/or in an associated client device, such as the client device 182 of FIG. 2. Other implementations can also be used.

Stage 1702 defines advertising campaign data. For example, the client device 182 and/or the content object manager 180 can be used to define an advertising campaign, e.g., a series of advertisements related to the release of a movie from a production studio.

Stage 1704 associated content objects with the advertising campaign data. For example, the client device 182 and/or the content object manager 180 can be used to associate existing or new content objects with the advertising campaign. For example, a set of content objects can be associated with the advertising campaign data so that the presentation of an edited media instance 116 will cause advertisements related to the campaign to be requested and served.

Stage 1706 provides the advertising campaign data and associations with content objects to an advertising system. For example, the client device 182 and/or the content object manager 180 can be used to upload the advertising campaign data and associations with content objects to an advertising system.

In an implementation, an advertising campaign can be revised. For example, a set of content objects 114 can be generated for a movie. A first advertising campaign can be defined for the theatrical run of the movie; a second advertising campaign can be generated for the DVD release of the movie; and a third advertising campaign can be generated for a post-DVD release of the movie. By updating advertising campaigns and associating the advertising campaigns with content objects, presentation of edited media items that include the content objects, e.g., fan movies, will result in the selection and serving of up-to-date and relevant advertisements.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A system, comprising:
a data store storing content objects, the content objects comprising data to facilitate the selection of one or more content items related to the content objects from a content item server; and
a media editor subsystem configured to receive a media instance and editing commands and perform editing operations on the media instance in response to the editing commands, the editing operations including receiving a selection for one or more of the content objects and associating the selected content objects with the media instance, and further configured to store the edited media instance.

2. The system of claim 1, wherein:
the content items comprise advertisements; and
the content item server is an advertisement server.

3. The system of claim 1, wherein:
the media instance comprises a video instance.

4. The system of claim 3, wherein:
the video instance is a streamed instance received from a client device; and
the editing commands are received from the client device.

5. The system of claim 3, wherein:
the content objects data comprise content metadata, the content metadata to facilitate the selection of one or more advertisements from an advertisement server.

6. The system of claim 5, wherein:
the content metadata includes user-identified metadata.

7. The system of claim 3, wherein:
the content objects comprise effects objects that are configured to generate media effects in the edited media instance.

8. The system of claim 7, wherein:
the media effects comprise one of an audio effect or a visual effect.

9. The system of claim 3, wherein:
the content objects comprise a category identifier.

10. The system of claim 3, wherein:
the content objects comprise static objects that are configured to be presented in the edited media instance.

11. The system of claim 3, wherein:
the content objects comprise dynamic objects that are configured to be presented in the edited media instance and change state during a presentation of the edited media instance.

12. The system of claim 11, wherein:
the dynamic objects are selectable and comprise a resource locator associated with a landing page, and wherein the selection of a dynamic object at a client device causes the client device to generate a browsing instance resolved to the landing page.

13. The system of claim 3, wherein:
the content objects comprise audio objects that are configured to be presented with the edited media instance.

14. The system of claim 13, wherein:
the audio object is a musical object.

15. The system of claim 3, further comprising:
a publisher subsystem configured to serve the edited media instance in response to a media request, and configured to combine the edited media instance and one or more advertisements served from an advertisement server that are related to the selected content objects into a video stream.

16. The system of claim 15, wherein:
the publisher subsystem is configured to cause one or more of the advertisements to be presented prior to the presentation of the edited media instance.

17. The system of claim 16, wherein:
an advertisement presented before the presentation of the edited media instance includes a selectable link to a landing page.

18. The system of claim 15, wherein:
the publisher subsystem is further configured to insert an advertisement served from the advertisement server into the edited media instance.

19. The system of claim 18, wherein:
the advertisement inserted into the edited media instance comprises an overlay related to one or more of the selected content objects.

20. The system of claim 19, wherein:
the publisher subsystem is further configured to provide a publication of the edited media instance to one or more applications.

21. The system of claim 20, wherein:
the publication comprises a link to the edited media instance;
wherein a selection of the link causes the publisher subsystem to serve the edited media instance and an advertisement subsystem to select and serve one or more advertisements related to the selected content objects associated with the edited media instance.

22. The system of claim 21, wherein:
the publisher subsystem is further configured to transcode the edited media instance into one or more media formats compatible with the one or more applications.

23. The system of claim 3, further comprising:
a content object manager configured to store and delete content objects in the data store.

24. The system of claim 23, wherein:
the content object manager is further configured to manage one or more customer accounts and associate content objects with corresponding customer accounts.

25. The system of claim 2, further comprising:
an advertisement subsystem configured to select and serve one or more advertisements related to the selected content objects associated with the edited media instance.

26. The system of claim 25, further comprising
an accounting subsystem configured to account for events related to the one or more advertisements served by the advertisement server.

27. A system, comprising:
a client device comprising a processing subsystem, and input/output subsystem, a data store and a communication subsystem, the processing device in communication with the communication subsystem, the input/output subsystem, and the data store, and the data store storing instructions that upon execution by the processing subsystem causes the client device to:
generate a media editor user interface;
generate a media editor command to select a media instance for editing by a media editor;
generate a media editor command to select a content object for association with the media instance, the content object comprising content metadata to facilitate selection of one or more content items based on the content metadata; and
generate a media editor command to store the edited media instance in a data store.

28. The system of claim 27, wherein the media instance is a video instance.

29. The system of claim 28, wherein:
the content metadata includes user-identified metadata.

30. The system of claim 28, wherein:
the content objects comprise effects objects that are configured to generate media effects in the edited media instance.

31. The system of claim 30, wherein:
the media effects comprise one of an audio effect or a visual effect.

32. The system of claim 28, wherein:
the content objects comprise static objects that are configured to be presented in the edited media instance.

33. The system of claim 28, wherein:
the content objects comprise dynamic objects that are configured to be presented in the edited media instance and change state during a presentation of the edited media instance.

34. The system of claim 33, wherein:
the dynamic objects are selectable and comprise a resource locator associated with a landing page, and wherein the selection of a dynamic object at another client device causes the another client device to generate a browsing instance resolved to the landing page.

35. The system of claim 28, wherein:
the content objects comprise audio objects that are configured to be presented with the edited media instance.

36. The system of claim 28, wherein:
the content items comprises advertisements.

37. A method, comprising:
storing a video instance related to content, the video instance including an associated content object related to the content, the content object including data to facilitate the selection of one or more advertisements related to the content objects from an advertisement server; and
serving the video instance in response to a request.

38. The method of claim 37, further comprising:
receiving the video instance as a stream from a client device; and
receiving editing commands from the client device.

39. The method of claim 37, wherein:
the content objects comprise content metadata that facilitates the selection of one or more advertisements from the advertisement server.

40. The method of claim 39, wherein:
the content metadata includes user-identified metadata.

41. The method of claim 37, wherein:
the content objects comprise effects objects that generate video effects based on the effects objects in the video instance.

42. The method of claim 37, wherein:
the content objects comprise a category identifier.

43. The method of claim 37, wherein:
the content objects comprise static objects that are configured to be presented in the video instance.

44. The method of claim 37, wherein:
the content objects comprise dynamic objects that are configured to be presented in the video instance and change state during a presentation of the video instance.

45. The method of claim 37, further comprising:
serving the video instance and the selected one or more advertisements as separate video streams.

46. The method of claim 37, further comprising:
inserting an advertisement served from an advertisement server into the video instance.

47. The method of claim 37, further comprising:
inserting a logo overlay advertisement related to one or more of the content objects into the video instance so that the logo overlay is presented during a presentation of the video instance.

48. A system, comprising:
a data store storing a video instance related to content, the video instance including an associated content object related to the content, the content object to facilitate the selection of one or more advertisements related to the content; and
an advertisement subsystem configured to select and serve one or more advertisements related to the associated content object.

49. The system of claim 48, wherein:
the advertisement subsystem is configured to select and serve one or more video advertisements related to the associated content object.

50. The system of claim 48, wherein:
the advertisement subsystem is configured to select and serve one or more text advertisements related to the associated content object.

51. The system of claim 48, wherein:
the content object comprises content metadata, the content metadata to facilitate the selection of one or more advertisements from the advertisement server.

52. The system of claim 51, wherein:
the content metadata includes user-identified metadata.

53. The system of claim 48, wherein:
the content object comprises data configured to generate video effects in the video instance.

54. The system of claim 48, wherein:
the content object comprises a dynamic object that is configured to be presented in the video instance and change state during a presentation of the video instance.

55. The system of claim 48, wherein:
the dynamic object is selectable and comprises a resource locator associated with a landing page, and wherein the selection of the dynamic object at a client device causes the client device to generate a browsing instance resolved to the landing page.

56. Software stored in a computer-readable medium, the software comprising instructions that upon execution cause a processing system to:
receive a content item request related to a content object of a video instance related to content, the content object related to the content;
select one or more content items related to the content object; and
serve the selected one or more content items in response to the content item request.

57. The software of claim 56, comprising further instructions stored in a computer-readable medium that upon execution cause a processing system to:
select one or more video content items for presentation prior to presentation of the video instance.

58. The software of claim 56, comprising further instructions stored in a computer-readable medium that upon execution cause a processing system to:
select a logo overly content item for presentation with the video instance.

59. The software of claim 56, comprising further instructions stored in a computer-readable medium that upon execution cause a processing system to:
serve the video instance and the selected content items in a single video stream.

60. The software of claim 56, wherein:
the content items comprise advertisements.
